(19) United States
(12) Patent Application Publication
(10) Pub. No.: US 2007/0251709 A1
(43) Pub. Date: Nov. 1, 2007

(54) Pneumatic tool

(76) Inventors: Yung-yung Sun, Dali City (TW); Chuan-ching Cheng, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/411,779

(22) Filed: Apr. 27, 2006

(51) Int. Cl. B25D 11/00

(52) U.S. Cl. 173/104

(57) ABSTRACT

A pneumatic tool including a cylindrical main body in which a speed-adjusting section is disposed and a hollow barrel-shaped plastic sleeve fitted around the main body. The speed-adjusting section is connected with an inner annular wall axially extending from one end of the speed-adjusting section and outwardly protruding from the main body. Two opposite pin seats having pinholes are disposed on of the plastic sleeve. A pin member is fitted through two lugs of a press lever and the pinholes of the pin seats to pivotally connect the press lever with the plastic sleeve. An annular receiving space is defined between an outer circumference of the annular wall of the main body and an inner circumference of the plastic sleeve. An additional annular muffling member can be fitted in the annular receiving space to enhance the muffling effect.

### BACKGROUND OF THE INVENTION

The present invention is related to an improved pneumatic tool in which the press lever is directly pivotally connected with the pin seats of the plastic sleeve to simplify the processing procedure of the main body.

FIGS. 4 to 6 show a conventional pneumatic tool having a handle main body 61. The handle main body 61 is an elongated cylindrical body made of a hard metal material by means of milling and processing. One end of the handle main body 61 has' a solid coupling section 62 formed with a pinhole 63. Only after the handle main body 61 is processed, the handle main body 61 can be drilled with the pinhole 63. In addition, the handle main body 61 has an inner annular wall 64 integrally connected with the solid coupling section 62. A plastic sleeve 71 is fitted around the handle main body 61 for a user to hold. The plastic sleeve 71 is a tubular body made by plastic injection molding. The plastic sleeve 71 is formed with a window 72 on one side. After the handle main body 61 is assembled with the plastic sleeve 71, two lugs 681 of a press lever 68 extend through the window 72 into the plastic sleeve 71 and a pin member 682 is fitted through the pinhole 63 and the lugs 681 to pivotally connect the press lever 68 with the handle main body 61. An annular muffling member 73 is mounted at a rear end of the plastic sleeve 71. When the air is exhausted from the pneumatic motor (not shown) in the handle main body 61, the air goes through the muffling member 73 to muffle the noise.

The conventional pneumatic tool has some shortcomings as follows:
1. It is complicated to process the handle main body 61 and the manufacturing cost is high. The handle main body 61 is made of hard metal material. After a blank of the handle main body 61 is molded by means of a mold, it is necessary to first mill the blank and then drill the solid coupling section 62 with the pinhole 63 for pivotally connecting the press lever 68 with the handle main body 61. Such processing procedure is complicated.
2. It is impossible to install another muffling member in the handle main body 61 to effectively muffle the noise generated when exhausting the air. This is because the solid coupling section 62 of the handle main body 61 is integrally connected with the annular wall 64. The solid coupling section 62 occupies the room between the inner circumference of the handle main body 61 and the annular wall 64. Therefore, it is impossible to additionally install another muffling member in the handle main body 61. As a result, when the air is exhausted from the pneumatic motor in the handle main body 61, only the muffling member 73 installed at the rear end of the plastic sleeve 71 serves to muffle the noise. The muffling effect is limited.

### SUMMARY OF THE INVENTION

It is therefore a primary object of the present invention to provide an improved pneumatic tool in which the pinholes of the plastic sleeve are formed at the same time when the plastic sleeve is molded. Therefore, the press lever can be directly pivotally connected with the pin seats of the plastic sleeve to simplify the processing procedure of the main body.

It is a further object of the present invention to provide the above pneumatic tool in which when the plastic sleeve is fitted around the main body, an annular receiving space is defined between an outer circumference of the annular wall of the main body and an inner circumference of the plastic sleeve. An annular muffling member can be fitted in the annular receiving space around the annular wall in addition to the original muffling member installed in the rear end of the plastic sleeve. Therefore, the two muffling members can achieve enhanced muffling effect to reduce the noise.

According to the above objects, the pneumatic tool of the present invention includes: a cylindrical main body in which a speed-adjusting section is disposed, the speed-adjusting section being connected with an inner annular wall axially extending from one end of the speed-adjusting section and outward protruding from the main body, the annular wall having an outer diameter smaller than an outer diameter of the main body; and a hollow barrel-shaped plastic sleeve fitted around the main body, two opposite pin seats being disposed on one side of the plastic sleeve, each pin seat having a pinhole, a pin member being fitted through two lugs of a press lever and the pinholes of the pin seats to pivotally connect the press lever with the plastic sleeve. An annular receiving space is defined between an outer circumference of the annular wall of the main body and an inner circumference of the plastic sleeve. The receiving space is free from any component of the pneumatic tool so that an annular muffling member can be fitted in the annular receiving space around the annular wall.

The present invention can be best understood through the following description and accompanying drawings wherein:

### BRIEF DESCRIPTION OF THE DRAWINGS

FIG. 1 is a perspective exploded view of the present invention;

FIG. 2 is a partially sectional assembled view of the present invention;

FIG. 3 is a sectional view taken along line 3-3 of FIG. 2;

FIG. 4 is a perspective exploded view of a conventional pneumatic tool;

FIG. 5 is a partially sectional assembled view of the conventional pneumatic tool; and

FIG. 6 is a sectional view taken along line 6-6 of FIG. 5.

### DETAILED DESCRIPTION OF THE PREFERRED EMBODIMENTS

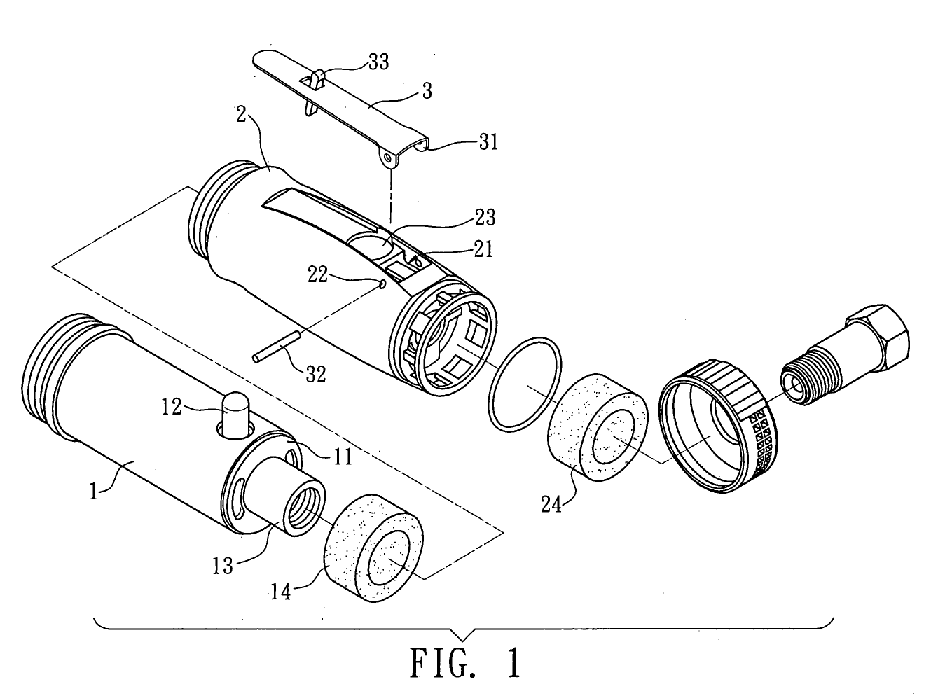

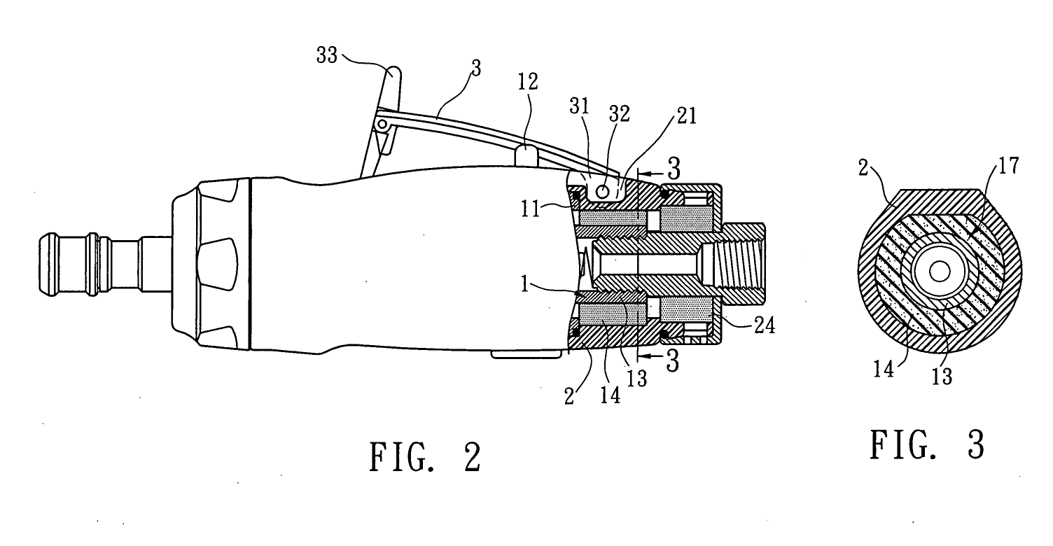

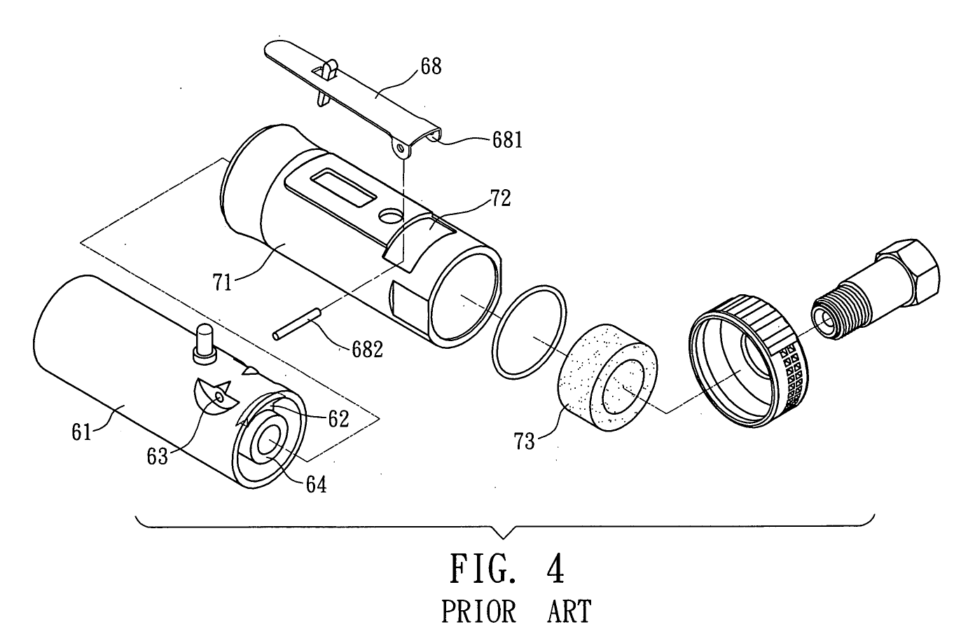

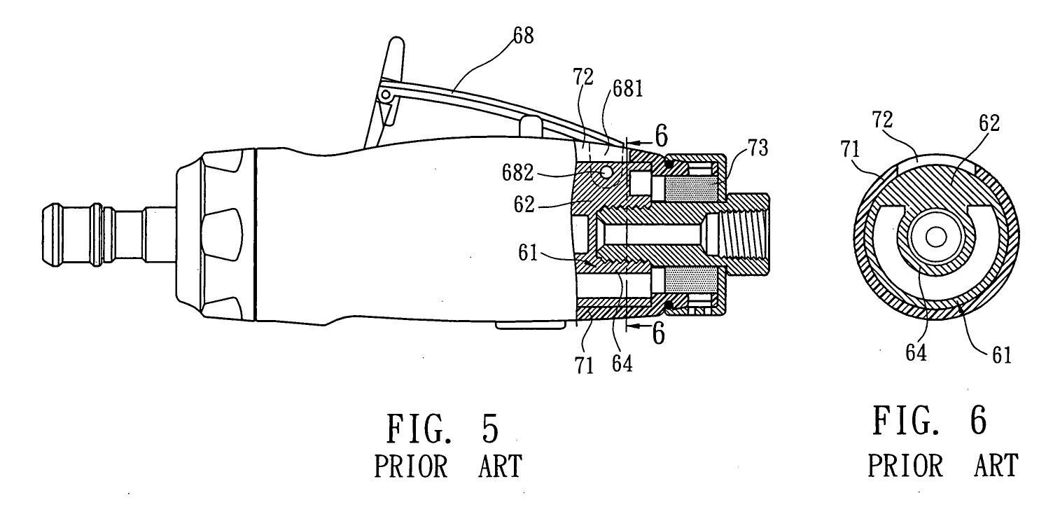

Please refer to FIGS. 1 to 3. The pneumatic tool of the present invention includes a cylindrical main body 1 made of hard metal material. A speed-adjusting section 11 is disposed in the main body 1. A press button 12 is radially mounted on the speed-adjusting section 11. One end of the press button 12 protrudes from a circumference of the main body 1. The speed-adjusting section 11 is connected with an inner annular wall 13 axially extending from one end of the speed-adjusting section 11 and outward protruding from the main body 1. The annular wall 13 has an outer diameter smaller than an outer diameter of the main body 1.

The pneumatic tool of the present invention further includes a hollow barrel-shaped plastic sleeve 2. Two opposite pin seats 21 are disposed on one side of the plastic sleeve 2. Each pin seat 21 has a pinhole 22. A pin member 32 is fitted through two lugs 31 of one end of a press lever 3 and the pinholes 22 of the pin seats 21 to pivotally connect the press lever 3 with the plastic sleeve 2. A freely switchable safety switch 33 is pivotally connected with the other end of the press lever 3. In addition, the plastic sleeve 2 is formed with a radial through hole 23 near the pin seats 21. The end of the press button 12 protrudes from the circumference of the main body 1 and extends through the through hole 23 to be pressed by the press lever 3.

After the plastic sleeve 2 is fitted around the main body 1, an annular receiving space 17 is defined between an outer circumference of the annular wall 13 of the main body 1 and an inner circumference of the plastic sleeve 2. The receiving space 17 is free from any component so that an annular muffling member 14 can be fitted in the annular receiving space 17 around the annular wall 13. In addition, another annular mufflingmember 24 can be installed in the rear end of the plastic sleeve 2. In use of the pneumatic tool, the two muffling members 14, 24 are able to achieve enhanced muffling effect for reducing the noise.

According to the above arrangement, the pneumatic tool of the present invention has the following advantages:
1. The processing procedure is simplified and the manufacturing cost is lowered. The pinholes 22 of the plastic sleeve 2 can be formed at the same time when the plastic sleeve 2 is molded. Therefore, the press lever 3 can be directly pivotally connected with the pain seats 21 of the plastic sleeve 2 to simplify the processing procedure of the main body 1. Accordingly, the manufacturing cost of the main body 1 is lowered.
2. A receiving space is reserved for an additional muffling member so as to enhance the muffling effect. After the plastic sleeve 2 is fitted around the main body 1, an annular receiving space 17 is defined between an outer circumference of the annular wall 13 of the main body 1 and an inner circumference of the plastic sleeve 2. An annular muffling member 14 can be fitted in the annular receiving space 17 around the annular wall 13 in addition to the original muffling member 24 installed in the rear end of the plastic sleeve 2. Therefore, in use of the pneumatic tool, when the air is exhausted from the pneumatic motor (not shown) in the main body 1, the air will goes through the two muffling members 14, 24 for effectively muffling the noise.

The above embodiments are only used to illustrate the present invention, not intended to limit the scope thereof. Many modifications of the above embodiments can be made without departing from the spirit of the present invention.

1. A pneumatic tool comprising:
a cylindrical main body in which a speed-adjusting section is disposed, the speed-adjusting section being connected with an inner annular wall axially extending from one end of the speed-adjusting section and outwardly protruding from the main body, the annular wall having an outer diameter smaller than an outer diameter of the main body; and
a hollow barrel-shaped plastic sleeve fitted around the main body whereby a press button of the speed-adjusting section extending transversely from the main body passes therethrough, two opposite pin seats being disposed on a side of the plastic sleeve, each pin seat having a pinhole, a pin member being fitted through two lugs of a press lever for the press button and the pinholes of the pin seats to pivotally connect the press lever with the plastic sleeve, an annular receiving space being defined between an outer circumference of the annular wall of the main body and an inner circumference of the plastic sleeve, the receiving space being free from any component of the pneumatic tool so that an annular muffling member can be fitted in the annular receiving space around the annular wall.
